(19) United States
(12) Patent Application Publication
(10) Pub. No.: US 2009/0197680 A1
(43) Pub. Date: Aug. 6, 2009

(54) WIDE AREA COMMUNICATIONS GAMING

(76) Inventors: Luc Maurice Emile St-Hilaire, (US); Robert Alexander Ford, (US)

Correspondence Address: CESARI AND MCKENNA, LLP, 88 BLACK FALCON AVENUE, BOSTON, MA, 02210, US

(21) Appl. No.: 12/023,610

(22) Filed: Jan. 31, 2008

(51) Int. Cl. A63F 9/24; G06F 19/00

(52) U.S. Cl. 463/42; 463/43

(57) ABSTRACT

A gaming system using wide area communications networks is disclosed. Slow, lossy wide area networks may include satellite and tower wireless paths along with the traditional Ethernet and other land line paths. The system replaces a traditional XML/TCP/IP protocol with a more efficient UDP protocol that speeds up the “round trip” time associated with gaming devices. Efficiency is also enhanced by reducing message content and the number of messages transferred and implementing the application code in binary which is compressed for additional time and size efficiencies. These time efficiencies allow hosts to handle tens of thousands of clients thereby reducing overall system costs. In addition, third party applications are accommodated.

### BACKGROUND OF THE INVENTION

1. Field of the Invention

The present invention relates to gaming systems and more particularly to communications between gaming devices or terminals and a central host, controller or manager.

2. Background Information

Standardized gaming communications protocols are designed for secure communications between a gaming device (e.g., a slot machine or lottery terminal) and a casino or lottery authority central management system.

SOAP (Simple Object Access Protocol) is a protocol of exchanging XML (Extensible Markup Language) based messages that is typically used as part of gaming protocols in a hierarchy of transport systems within the well-known layered model of network communications. Note that the distinctions between the model layers, e.g., the application layer followed by the transport, the network, the data link, and the physical layer may be somewhat blurred in that typical functions of one layer may be assumed by another layer, as those skilled in the art understand. For our purposes, the SOAP layer is an application and systems like the well known TCP and UDP (as discussed below) are transport systems.

Wide area communications networks may use satellites along with wireless tower and land line forms to handle gaming communications. These networks may have a number of limitations, e.g., hardware failures, network congestion, time delays, data corruption, packet/data duplication and other such errors. In light of these problems, typical systems in use provide reliable receipt of the data or information being sent, by employing SOAP/TCP systems that provide that reliability for the unreliable IP datagrams.

These limitations mentioned above, however, are amplified in some applications due to the volume of gaming communications between hosts and tens of thousands of gaming devices. Use of SOAP/TCP markedly reduces the system performance, e.g., the “round trip time” of a gaming communications between a client and a host. In an application where a host server controls a gaming device, it is important that the user client not wait for a host server to respond. The user expects that immediate response, and any delay will likely drive the user away.

In addition to a fast response or “round trip time,” there is desire to reduce the cost of the gaming devices and other infrastructure costs. For example, operators want less expensive slot machines since there are so many, and less expensive yet faster means of transporting the information (satellites, fiber optics, etc.) back and forth to a host. Lottery customers also want more but less expensive hardware, and they want that hardware to run faster. Moreover, agreements among the gaming device customers and service providers often specify “round trip times,” and other performance requirements. Another issue revolves around the wide area communications use of networks that are slow, noisy, lossy, high latency and low bandwidth.

Reliable information transfer remains a system requirement.

Prior art systems use application-type protocols, e.g., XML/SOAP/HTTP, that entail extensive overhead and require large amounts of time to processes information. It would be advantageous to reduce the application-type protocols to enhance system speed.

Existing transport mechanisms approach the above issues concerning reliable, fast information transfer between hosts and many clients by using the above mentioned SOAP/TCP/IP protocols. As is well known, the TCP transport system provides reliable communications. However, this SOAP/TCP/IP arrangement, especially when applied to the imperfect wide area networks, is slow and expensive and, when applied to wide area communications with tens of thousands of client devices, would require many expensive hosts. The result is that the SOAP/TCP systems cannot service the tens of thousands of clients efficiently, inexpensively or effectively.

In prior art gaming networks, the game outcome generation (i.e., RNG (Random Number Generator) and the outcome determination) is performed locally at each EGM (Electronic Gaming Machine). In these instances, central accounting data, communicated over the network, only comprises meter data (coin-in, coin-out, games played, etc.) and machine state data (door is open, printer is out of paper, etc.). In such prior gaming systems when the outcome generation task is moved to the host handling many EGM'S, network traffic increases significantly. The outcome generator uses a random number or math model to determine the win/loss/payout information and may also determine the visual representation of the outcome to be displayed by the EGM. The traffic increase results in poor system performance, especially when using SOAP/TCP protocols.

TCP is a connection-type transport using a three-step handshake to establish the communications path. Once established, information/data can be sent over the established path. When a path is broken it must be re-established using the same protocol. If a host server (host and host server are used herein synonymously) were communicating to tens of thousands of client devices, the establishing and breaking of the path to any one client, and the re-sending of information/data that was compromised in the transfer (as TCP would require), takes too much time to be cost and performance effective.

The prior art limitations and issues are addressed by the present invention.

### SUMMARY OF THE INVENTION

The present invention approaches the above limitations and issues in the prior art by reducing the number and content of the messages and speeding up the transfer of information/data.

In an illustrative embodiment, UDP (user defined protocol), a well-known transport protocol, is implemented. UDP is a “lightweight” or “lean” protocol with a basic structure with little overhead. Most typically, UDP includes a header containing a source and a receiving port, the length of the message, and a checksum. Moreover, UDP is a connectionless protocol, where a message may be sent to any client at any time without making a connection. UDP allows a single host server to handle the tens of thousands of clients in a time efficient manner while reducing the costs since the number of host servers is reduced. UDP replaces the TCP transport layer, and requires the application layer program, in this case the gaming communication protocol (or any open protocol), track and ensure proper receipt and integrity of the messages.

UDP also allows the transport layer to control of the “round trip time” so that service level agreements can be met, while the application controls the command flow. That is, any re-sending, ordering, etc., of messages is controlled by the application.

UDP, being lightweight, and connectionless, better fits the high latency, low bandwidths of wide area communication paths, and broadcast messages that go out to many clients are more easily implemented with the connectionless feature of UDP.

The present invention also provides for reduced message content by using binary in place of XML and implementing binary data compression. Illustratively binary compression reduces the size of messages. To efficiently operate over wide area networks, it is advantageous to reduce, where possible the size of the messages along with reducing the number of messages while increasing the speed of the communications, e.g., as discussed above by reducing the overhead associated with prior art systems.

In an illustrative embodiment, the game outcome is generated by the host server, the meter data (coin-in/out) that was handled by the EGM can now be generated by the host server so it no longer needs to be communicated over the network.

In an illustrative application, since UDP does not require a response (it is connectionless), the asynchronous character of the application is not needed. In such an instance, the application system can be used advantageously in a synchronous manner. In known systems, an asynchronous arrangement may send ordered messages over one communication channel and receiving responses over a second channel. However, in an illustrative application of the present invention, a client may send a request at the application level and wait for the response that will be returned on the same communication channel. This is herein defined as a synchronous arrangement. A separate communication channel would be used for hosts that originate a message to a client wherein the response is returned on the same channel.

In addition, rather than transferring an acknowledgement for each request as is now the case in a typical protocol example, the present invention reduces by half the number of messages, by incorporating the acknowledgement with the response message itself. For example, a “get-the-outcome” request can be acknowledged by returning the “central-outcome”, which serves as an acknowledgement of receipt of the request itself along with the information. The present invention uses a request/response mechanism to efficiently utilize the network.

In other applications, the present invention may be advantageously applied to particular applications and games. For example, such applications may include: games that allow a player to “double or nothing” his winnings; games where the game starts for the user and the result is assumed to be returned in time from the host. Prior art systems would have difficulty here. The handling of central accounting is facilitated with the present invention; and handling of possible third party games/applications is also facilitated using the present invention.

Illustratively as known to those skilled in the art, computer system operations implementing the present invention may be distributed between hardware and software and also between the host systems and client systems as applications may suggest to designers.

It will be appreciated by those skilled in the art that although the following Detailed Description will proceed with reference being made to illustrative embodiments, the drawings, and methods of use, the present invention is not intended to be limited to these embodiments and methods of use. Rather, the present invention is of broad scope and is intended to be defined as only set forth in the accompanying claims.

### BRIEF DESCRIPTION OF THE DRAWINGS

The invention description below refers to the accompanying drawings, of which:

FIG. 1A is a block diagram of a networked system;

FIG. 1B is a block diagram of illustrative computer system;

FIG. 2 is a block chart of a communications hierarchy;

FIG. 3 is a diagram of a UDP message;

FIG. 4 shows an illustrative communications channel between client and host;

FIG. 5 is a block flow diagram of a double-up game feature;

FIG. 6 is a block flow diagram of a proxy illustrative example; and

FIG. 7 is a block diagram illustrating use of a third party game server.

### DETAILED DESCRIPTION OF AN ILLUSTRATIVE EMBODIMENT

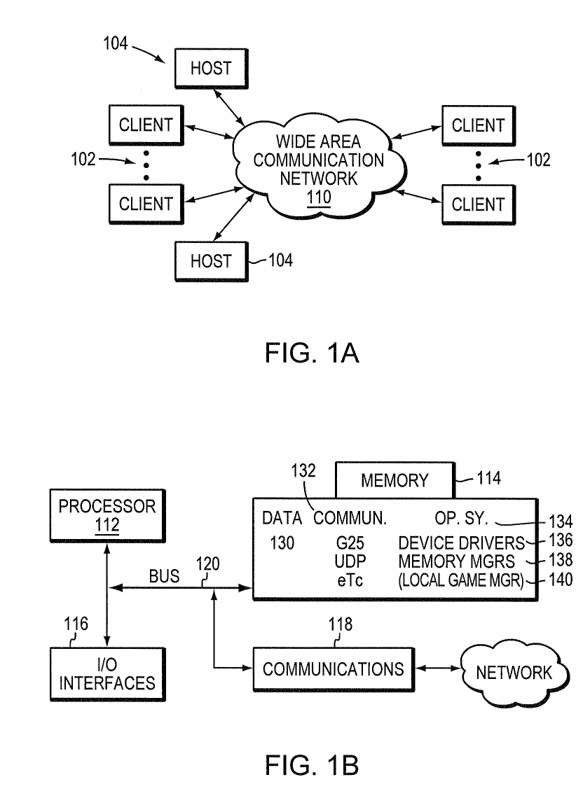

FIG. 1A is a schematic block diagram of a wide area computer network 100 that may include a plurality of clients 102 and a plurality of hosts 104. In this illustrative network, the wide area communication network itself 110 may include wireless paths (towers and satellite) as well as ground line communications. Hosts are typically computer servers that may run one or more applications on one or more platforms (hardware and software) suitable for the gaming industry. Clients are EGMs (Electronic Gaming Machines) that may be referred to herein as terminals or gaming devices, e.g., slot machines, lottery terminals, etc.

Typically, a host will interact with the clients on a client/server model of information delivery. That is, each client may request an outcome from a host and the host replies; and the host may request information (e.g., status) from the client.

FIG. 1B is an illustrative block diagram of hardware and some program modules that may be found in a typical host 104 or in a client 102. The difference will be that the host will be a much more powerful implementation that performs many operations at high speeds, while the client may be quite modest in hardware and processing speed. Regardless, similar electronic blocks may be found in each. A computer bus 120 connects a processor 112 to memory 114; to I/O (input/Output) interfaces 116; and to communications hardware 118 that connects to the network 110.

The processor 112 may be any processor or controller or control logic arranged to execute program code and exercise control over the module (host or client). Processors made by Intel, AMD, or any other manufacturer may be used, as well as ASIC (Application Specific Integrated Circuit) or other particular designs. The memory 114 usually includes a ROM and a RAM. Again, standard hardware may be used, including electronic or magnetic ROM and RAM, flash, optical, CD's, hard disk drives, etc. External memory, not shown, may be used and include disk and RAID systems. The I/O interfaces 116 may include drives for motors, LED and other displays, printers, touch screens, mouse and keyboard or key, and other such interfaces. The communications hardware 118 may include drives for discrete wires, twisted pairs, Ethernets, Optical fiber, wireless and any other transmission types known to those skilled in the art.

In FIG. 1B the memory is shown maintaining: a data storage 130 for local operations, a communications program stack 132 that implements the communications hierarchy; an operating system 134, device drivers 136, memory and other system managers 138 and local game control and operation software 140.

Service contracts often will set “round trip” timing limits that, if not met, require damages to be paid. Host servers may be expensive high performance computer systems, while client machines may be very simple low cost machines. The present inventive approach is to have one host service tens of thousands of clients in a timely fashion that does not trigger the “round trip” damages provisions that are found in some service contracts.

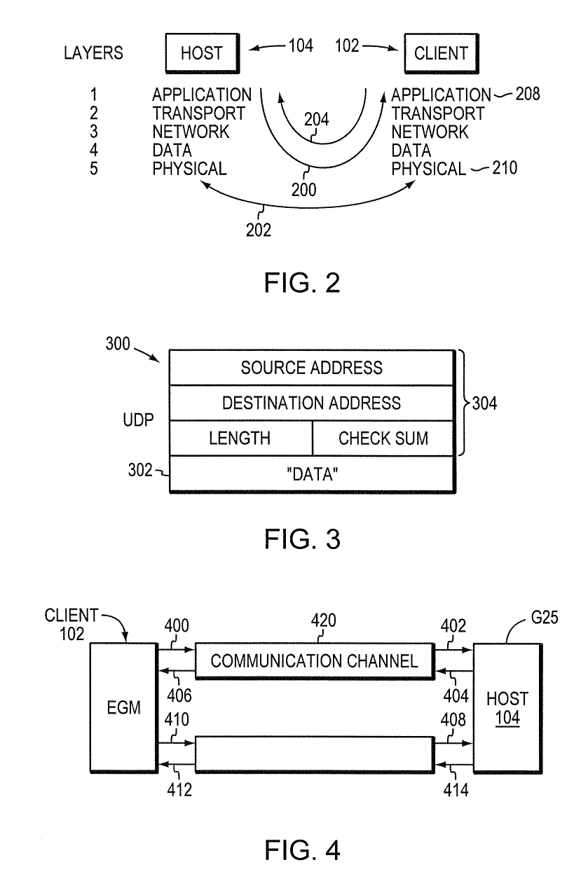

FIG. 2 depicts the familiar layer approach to communication of information. Here, a host 104, using an application on layer 1, sends a message (which may be a request or a response, etc.) to a client 102. The message is sent down 200 through the layers 1-4 to the physical layer 5 that drives the wide area communication network 110. At each layer down the stack a new header wraps the message. The added header (and possibly a footer at the end) has an address and other information that is well-known in the art. The wrapped message is received at the physical layer 210 of the client. The headers are unwrapped as the message travels up the stack to the application layer 208 of the client 102. Any response from the client 102 travels down 204 the layers in the client 204 and up the layers in the host 104.

As discussed above, the transport mechanism used in the gaming industry includes the TCP/IP protocol. TCP is a connection protocol that establishes a connection before sending information. This is too slow and/or too expensive when applied to wide area communications for gaming applications.

The present invention replaces the TCP with a UDP (User Defined Protocol). A UDP message packet 300 showing the information fields is illustrated in FIG. 3. Here, the message data 302 is wrapped in a header 304 of only four fields. The header 304 comprises source and destination addresses, the length of the packet being sent and a checksum. The message data 302 may be very long as an application may require. Also, since the UDP packets 300 are connectionless, there is no wasted time making and keeping open (and reopening, etc.) connections as in the TPC/IP protocol.

In gaming applications, the application layer 208 of FIG. 2 is typically a gaming communication protocol with systems (logic programs) to ensure secure, reliable communications. The protocol has built-in systems to survive sessions where communications are dropped (interrupted), corrupted or otherwise not received. This relieves the transport layer from any responsibilities to message integrity.

FIG. 4 illustrates an operation of an EGM client 102, sending a request 400 via a communication channel 420 to a host 104. The communication channel 420 from the EGM appears as a single request/response channel (the lower layers of FIG. 2 are invisible to the application). The request message is sent and the EGM waits for a response on the same channel. This is no hardship since the single gaming device, the EGM, and the human user, will wait for the response. In a similar fashion, when the host 104 initiates a request to an EGM, the host expects the response on the same channel. This is different from the prior art arrangement where the EGM and the host send requests on one channel and receive responses on a different channel.

In addition, the protocol may be configured to more efficiently correlate requests and responses. In prior art protocols, messages are ordered and each message sent waits for an acknowledgement before the next ordered messages is sent between hosts and clients. The present invention provides that a substantive response to a message inherently is also an acknowledgement that the initial message was properly received. Here, the messages need not be ordered and acknowledgements by the substantive response need not be received before another message is sent. The application must still guarantee that the proper response was received, and if not than the application must re-send or otherwise correct the problem. But, the ordering and waiting is not needed in the present invention.

FIGS. 1 through 4 illustrate both hardware and software systems that allow a host computer system to control one or more client computer systems using a connectionless UDP protocol. As known to those skilled in the art, the computer functions may be distributed between the hardware and the software and also between the host and the client computer systems. Illustratively, the software is contained in a. computer readable medium containing executable program instructions or code, wherein the executable program instructions comprising one or more instructions for generating an outcome of one or more games; running a communication protocol in both the host and one or more client computer systems; communicating between the host and the one or more client computer systems, executing a connectionless transport layer in the communication protocol in both the host and the one or more client computer systems; and outputting the one or more game outcomes to the one or more client computer systems. In addition the program instructions executing the connectionless protocol may include instructions for executing a UDP (user defined protocol).

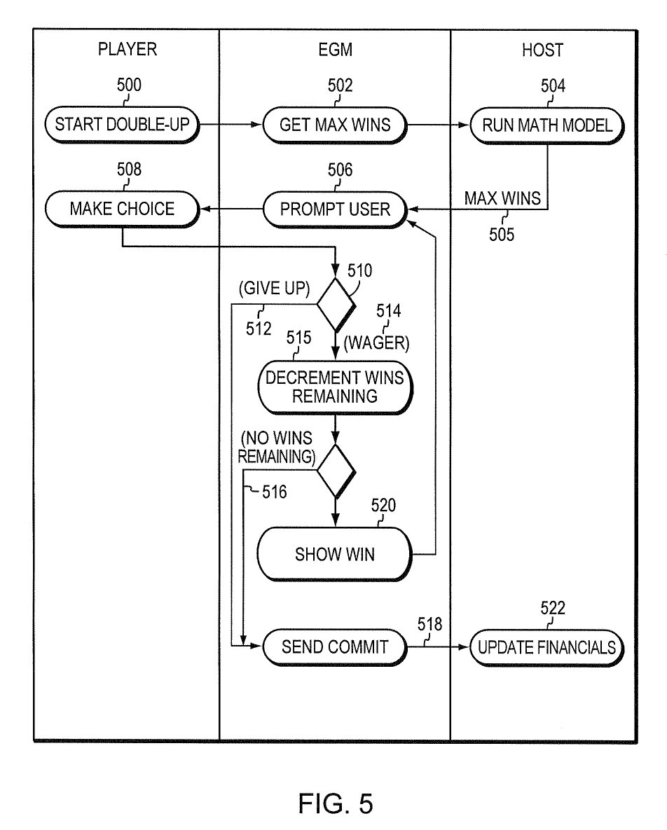

FIG. 5 is a flow chart illustrating typical operations of a “double-up” game where the host provides and controls all financial accounting and game outcome determination. The EGM may have a current credit meter in case of a network failure, but the official credit meter will be stored in the host. A “double-up” game is one where a player is allowed to risk his/her most recent winnings where it will be doubled or lost. This risk reward choice continues until the winnings are lost or distributed to the player. Many different types of games, e.g., coin flipping, selecting red or black sequences or where you win or lose to a dealer, etc.

The player, in FIG. 5, selects the double-up feature 500 and that selection is entered into his/her gaming device or EGM usually via hitting a button. The EGM sends the selection to the host 504 where the game outcome is generated and the result returned to the EGM 506 and then to the EGM 508. In this particular application, the host will determine how many double-ups 502 that will win before the user loses, and returns this number 505 to the EGM. The EGM decrements this number each time the player selects “double-up.” If the resulting number reaches zero, the user loses all he/she has wagered. The player may choose to give up 510 before zero is reached. In this case, the host will be informed 518 and return a valid financial result 522.

For example, the user wagers 514 another double-up, as mentioned above, the number of wins is decremented 515 and the game presentation is made to the player. If the number of wins remaining remains positive 520, the player is prompted 506 locally and his/her present financial status with respect to the player's gaming session is presented to him 506. The player can continue the double-up until the number of wins remaining reaches zero whereupon, if double-up is played one more time, the wager is lost. This is determined 516 and a commit message is sent 518 to the host where the host verifies the status. If the player selects give up 516, the status is sent to the host via the commit 518 whereupon the host again verifies 522 the financial result.

In this double-up application, there will be only one request message (double-up selected) sent to the host, one response (number of times the double-up will win before a loss is encountered) from the host, and one “commit” message to the host verifying the amount of winnings at the end. In this application, all the financial accounting and game outcome generation is performed by the host. The EGM may have a local current credit meter, but the official financial meter resides with the host. Money (bills, coins or verified receipts) may be inserted into the EGM and validation requested from the host. Illustratively, the host will verify the local credit meter and store the validated credit amount. The EGM credit meter may be disabled or corrected when discrepancies are detected.

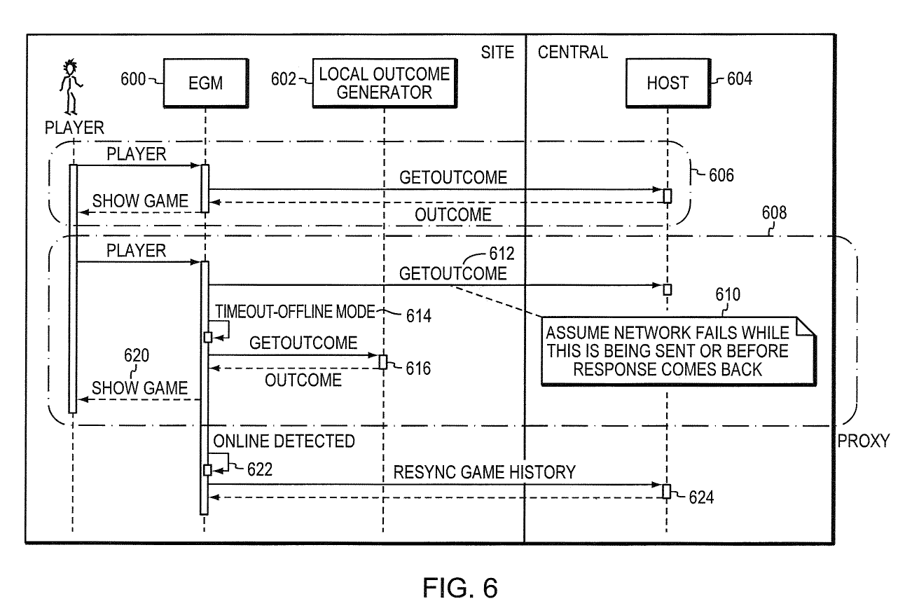

FIG. 6 illustrates a “terminal proxy” mode where, when a central host determines wins and losses, the timing of a game sequence does not wait for the host's response. In prior art applications, the game must wait for the host to respond before the game commences; but, as known to those skilled in the art, any delay experienced by the human user is detrimental to the game. The present invention provides that the game starts when the user initiates it. For example, the wheels on a slot machine may start spinning before the host responds, but where the host is expected to respond before the wheels stop. In this manner, the user is led to believe the result was determined locally in the EGM. If, for some reason, the host does not respond in time, the EGM may continue the wheels spinning until a response is received. In some instances, a local outcome generator may be employed in the EGM where the game is completed and the results are buffered (stored). The local results are kept until the communications to the host are reestablished. However, the host and the EGM must then be synchronized, and this presents problems that must be managed. Limits may be imposed on such locally operated games that, if exceeded, result in the EGM being shut down.

In FIG. 6, item 600 is the human user's EGM, 602 is a local outcome generator, and 604 is the host. Transaction 606 represents a typical gaming interaction, for example, as described above, for a double-up game. Here, the host 604 controls the outcome and all the financial accounting.

However, transaction 608 illustrates a communication failure 610 between the EGM 600 and the host 604. When GetOutcome 612 is requested from the host, there is no response. In such an instance, the EGM times out 614 and the EGM requests an outcome 616 from the Local Outcome Generator 602, which responds with the game outcome that is shown 620 to the user. When the system is back on-line 622, the Local Outcome Generator or manager (140 in FIG. 1B) and the host re-synchronize 624 the game history. That is, the EGM 600 stores the locally the game outcomes and sends those results back to the host 604. Normal operations as in item 606 then resume.

In the prior art gaming network, the central accounting data (meter data) is uploaded from the EGMs to the host on demand only and, typically, only at the end of each day. If an EGM meter data went corrupt before the upload, the data would be lost and there may be a discrepancy between the EGM data and the host data. In the present invention, real-time financial data is tracked and stored by the central host concurrently as the outcomes are generated. Therefore, there is no uploading of financial data required from the EGMs, the host is always up-to-date.

For example, the present invention provides the ability to recover the financial accounting of a gaming device instantaneously and re-establish the “state” instantaneously after a communication disconnection reconnection cycle. There is no need to “replay” the games upon reconnection to bring the financial data and “state” up-to-date. Illustratively, in the present invention, every transaction (in real time) is logged by the EGM and sent to the host server so, on re-connection, no replay is needed.

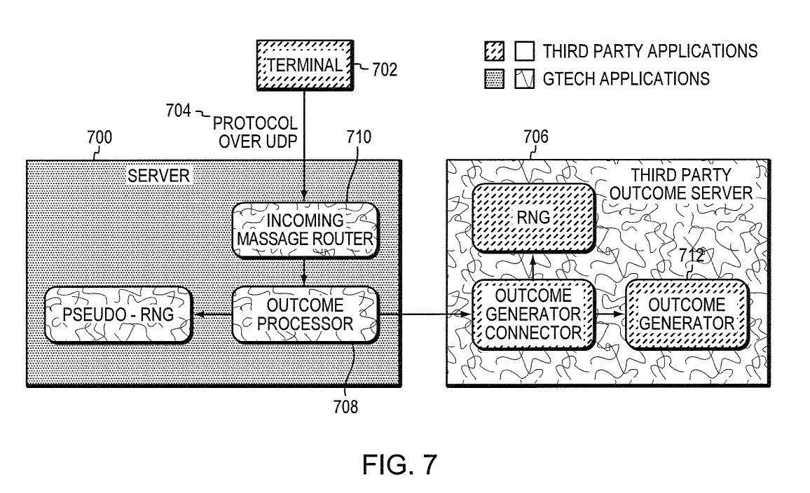

FIG. 7 illustrates an alternate deployment for using the present invention for managing third party games and/or applications. In this case, the present invention provides the network, the security, integrity and message-routing for third parties. The third party could use an open protocol or virtually any of the standard gaming industry protocols and, thus, not be bound to a proprietary communications protocol or API (application programmers interface) to communicate from a third party outcome generator to the host. The UDP of the present invention would still be used to communicate from the host to the EGMs. In such case, the RNG (random number generator) might be provided by the third party, or by the present invention, or the present invention may provide a “seed” (a term of art) to the third party's RNG.

In FIG. 7, the server 700 contains an embodiment of the present invention and serves as a conduit for an EGM terminal 702 communicating via a UDP 704 as discussed herein. The terminal 702 message is routed 710 to an outcome processor 708 that communicates with the third-party outcome generator 712. The RNG from the server 700 or the third-party server 706 may be used in the game. The third-party outcome generator 712 may be directed to the terminal 702 via the server 700.

In this fashion, the present invention provides a flexible interface for a third-party server to operate gaming device over the efficient communications provided by the present invention.

It should be understood that above-described embodiments are being presented herein as examples and that many variations and alternatives thereof are possible. Accordingly, the present invention should be viewed broadly as being defined only as set forth in the hereinafter appended claims.

What is claimed is:

1. A gaming system comprising:
a wide area communication network;
a host having a computer system that generates one or more game outcomes, the host running a communication protocol;
a first communications connection from the host to the wide area network;
a client having a computer system running the communication protocol;
a second communications connection from the client to the wide area network;
wherein the communication protocol comprises a transport layer including a connectionless protocol, and wherein the connectionless protocol includes a message architecture including a source and a destination address field.

2. The gaming system of claim 1 wherein one host computer system communicates with a multitude of clients computer systems and controls the game outcome generation of all the client computer systems.

3. The gaming system of claim 1 wherein the communications protocol further includes a field containing the length of the message, and a checksum.

4. The gaming system of claims 1 where in the transport layer communication protocol comprises a user defined protocol.

5. The gaming system of claim 1 wherein the client computer system includes a local game outcome manager.

6. The gaming system of claim 5 wherein the client computer system and the host computer system both have a re-synchronized program that allows the host system to be updated whenever the client computer system locally runs a game without communicating the game to the host.

7. The gaming system of claim 4 further comprising functional connects to third party applications, wherein the third party application determines game outcomes that are transferred to the client system via the host and client running the communications protocol.

8. The gaming system of claim 1 wherein the host computer system includes a binary application program and wherein that binary application program is compressed.

9. The gaming system of claim 1 further comprising a third party application program that is executed by the host computer system.

10. The gaming system of claim 1 wherein real-time financial data is stored at the host.

11. A method for running a gaming system, the method comprising the steps of:
connecting a host computer system that controls the game outcome generation of the gaming system, and a client computer system to a wide area communication network;
running a communication protocol in both the host and the client systems;
executing a connectionless transport layer of the communications protocol in both the host and the client, wherein the connectionless protocol includes a message with a source and a destination address field.

12. The method of claim 11 wherein the step of running a communications protocol includes the steps of one host communicating with a multitude of clients computer systems and controlling the game outcome generation of all the client computer systems.

13. The method of claim 11 wherein the running of the communication protocol comprising the step of utilizing a message with a field containing the length of the message and a field containing a checksum.

14. The method of claims 11 where in the step of executing a connectionless transport layer transport layer communication protocol comprises a user defined protocol.

15. The method of claim 11 further comprising the step of the client computer system running a local game outcome manager.

16. The method of claim 15 wherein the local game outcome manager is employed when there is no response from the host in a predetermined amount of time.

17. The method of claim 15 further comprising the step of re-synchronizing the client and the host computer systems whenever the client computer system locally runs a game without communicating the game to the host.

18. The method of claim 11 wherein game outcome generation includes a pseudo random number generator and an outcome determination module.

19. The method of claim 11 wherein the host computer system includes a binary application program and wherein that binary application program is compressed.

20. The method of claim 11 further comprising the step of the host computer system executing a third party application program.

21. The method of claim 11 further comprising the step of storing real-time financial data at the host.

22. A computer readable medium containing executable program instructions, the executable program instructions comprising one or more instructions for:
generating an outcome of one or more games;
running a communication protocol in both a host and one or more client computer systems;
communicating between the host and the one or more client computer systems,
executing a connectionless transport layer in the communication protocol in both the host and the one or more client computer systems; and
outputting the one or more game outcomes to the one or more client computer systems.

23. The computer readable media of claim 22, wherein the program instruction for executing the connectionless transport layer includes instructions executing a user defined protocol.
